(19) United States
(12) Patent Application Publication
(10) Pub. No.: US 2024/0291364 A1
(43) Pub. Date: Aug. 29, 2024

(54) ELECTRICAL MACHINE WITH AXIALLY-EXTENDING FLUX

(71) Applicant: ePropelled Inc., Lowell, MA (US)

(72) Inventors: Nabeel Ahmed Shirazee, Cardiff (GB); Manikandan Adhimoolam, West Midlands (GB)

(73) Assignee: ePropelled Inc., Lowell, MA (US)

(21) Appl. No.: 18/176,193

(22) Filed: Feb. 28, 2023

(51) Int. Cl. H02K 16/02; H02K 1/2795

(52) U.S. Cl. CPC H02K 16/02; H02K 1/2795; H02K 2201/03

(57) ABSTRACT

A permanent magnet electrical machine comprises a stator 12 having a plurality of stator coils 15 extending around respective stator teeth 14, the coils 15 having respective coil axes extending parallel to the rotational axis of the machine. A rotor 20 axially spaced apart from the stator 12 has a plurality of circumferentially arranged permanent magnets 21. The stator teeth 14 and magnets 21 comprise opposed faces on opposite sides and an air gap 23, the faces being of a complementary profile having both a radially facing, in-between facing and an axially-facing component of inclination relative to the rotational axis of the machine. The inclination of the opposed faces maximises the active surface area for magnetic flux thereby substantially increasing the power density and efficiency of the motor compared with conventional axial flux machines.

### BACKGROUND

### 1. Field of the Invention

This invention relates to an electrical machine with axially-extending flux which may function as either a motor or a generator, or both (at different times).

### 2. Related Background Art

Permanent magnet electrical machines are preferred due to their high torque density and efficiency and are broadly classified as axial flux, radial flux and trans-axial flux type machines. As the demand for higher specific power density increases, electrical machines of the axial flux type are considered advantageous over the other types of electrical machines as they have several advantages, such as a high power-to-weight ratio, a high torque capability, and a compact design.

A conventional axial flux machine comprises one or more stators and/or rotors that are arranged in an axial direction i.e., the air gap between the stator and rotor is perpendicular to the axis of the shaft. The stator further comprises a plurality of coils each parallel to the axis of rotation and the rotor has a plurality of magnets distributed on the surface of the rotor facing the stator/s. The rotor/s is mounted and rotated on bearings by the rotating magnetic field generated by the stator coils. The rotor magnets are being pulled by this rotating magnetic field of the stator.

A conventional axial flux machine comprises a fixed stator having electromagnetic coils wound on respective teeth of a ferromagnetic former and disposed circumferentially at intervals about a rotational axis of the machine, and at least one rotor provided with a plurality of permanent magnets and mounted for rotation about the axis. The opposed surfaces of the ends of the stator teeth and the surfaces of the permanent magnets lie in respective planes which extend perpendicular to the rotational axis of the machine. The rotor and stator(s) are spaced apart along the axis to define a gap between the opposed planar surfaces in which magnetic flux in the machine extends generally axially of the rotational axis.

It is well known that in order for an electrical machine of the axial flux type to operate efficiently, the gap between the rotor and stator should be as small as possible. If the gap between the rotor and stator is very small, very tight tolerances are imposed on the dimensions of the stator housing, in particular, the spacing and degree of parallelism between radial end walls of the stator housing. U.S. Pat. No. 10,608,512 discloses an electrical machine of the conventional type which attempts to achieve a high efficiency using a small air gap that is formed during manufacture using one or more collapsible elements. These collapsible elements are disposed between one or each radial end wall and the generally cylindrical side walls of the motor housing and can be precisely collapsed during manufacture in order to accurately control the spacing and parallelism of the radial and end walls.

U.S. Pat. No. 10,566,866 discloses a similar electrical machine of the axial flux type in which the magnets are disposed circumferentially around the rotor and define a plurality of matching sets of magnets. Each set of magnets includes a plurality of magnets, wherein the sets of magnets on the rotor have n-fold rotational symmetry. Within a set, the magnets have different shapes and/or relative circumferential spacings of adjacent magnets within the set of magnets are irregular.

The object of the U.S. Pat. No. 10,566,866 is to reduce cogging by employing an arrangement of magnets which has n-fold symmetry, but which is ‘asymmetric’ within an n-fold segment.

Whilst the aforementioned and other known electrical machines of the axial flux type have a reasonable specific power density, the increasing popularity of electrical propulsion and new applications create a demand for electrical machines which are smaller, lighter and have a much higher specific power density of at least 20 kW/kg, doubling what has been conventionally achieved. However, current design techniques are unable to achieve these demands without substantially increasing the electrical machine by using expensive active materials or expensive cooling methods.

The above-mentioned known axial flux machines attempt to improve the performance of axial flux machines in a complex and costly manner and there exists the need to provide a simple and inexpensive way of achieving a high torque density ideally exceeding 20 kW/kg.

With the forgoing in mind, disclosed is an electrical machine having an improved specific power density.

### SUMMARY

In accordance with embodiments of the invention, there is provided a permanent magnet electrical machine, the machine comprising:
a stator having:
   a plurality of ferromagnetic stator teeth disposed circumferentially at intervals about a rotational axis of the machine; and
   a plurality of stator coils having respective coil axes extending parallel to said rotational axis of the machine, each coil extending axially around a respective said stator tooth, and
a rotor having a plurality of permanent magnets disposed circumferentially around said rotor and mounted for rotation about said rotational axis of the machine, and wherein said rotor and stator are axially spaced apart along said rotational axis of the machine to define a gap therebetween in which magnet flux in the machine is generally in an axial direction, wherein said stator teeth and said magnets comprise opposed faces on opposite sides of said air gap of a complementary profile having both a radially-facing and an axially-facing component of inclination relative to said rotational axis of the machine.

The opposed faces on opposite sides of the air gap have an increased surface area compared with those of conventional axial flux permanent magnet electrical machines due to them having both a radially-facing and an axially-facing component of inclination relative to the rotational axis of the machine. Since the efficiency of a permanent magnet electrical machine is exponentially proportional to the active surface area of the magnetic flux between the ends of the stator teeth and the permanent magnets, the increased surface area of the present invention substantially increases the power density compared with conventional axial flux machines. Accordingly, the permanent magnet electrical machine of the present invention provides a much-improved way to increase the specific power density above 20 kW/kg using silicon-iron based electrical steel and above 40 kW/kg using cobalt-iron based electrical steels in combination with high energy permanent magnets.

In one embodiment one of the opposed surfaces may be convex and the other may be concave.

In another embodiment, the opposed surfaces may have a convex and a concave portion.

The opposed surfaces may have a flat portion and/or a curved portion. We have found that the use of curved opposed faces on opposite sides of the air gap increases the active surface area which in turn increases the torque and the specific power density of the machine by at least 10% in the same given volume of the electric machine. In another similar embodiment, the opposed faces on opposite sides of the air may be V-shaped. Such configurations offer improved active air gap surface area than conventional axial flux motors.

The machine may comprise a plurality of rotors and/or stators mounted axially of each other along said rotational axis of the machine.

The permanent magnets may be disposed on a face of a body portion of the rotor.

The body portion of the rotor may be formed of a ferromagnetic material.

The stator may be mounted inside a tubular housing of the motor.

The rotor may form an end wall of the housing.

The lines of flux extending in the active air gap may extend perpendicular to the respective points on the curved surfaces between which they extend. Alternatively, the lines of flux may extend in a non-perpendicular direction depending on the position of the rotating magnetic field relative to the permanent magnets.

By way of example, the coils can be rectangular, edge coil type, standard circular or flat tape types.

### BRIEF DESCRIPTION OF THE DRAWINGS

Embodiments of the present invention will now be described by way of examples only and with reference to the accompanying drawings, in which:

FIG. 1 is a sectional view of an embodiment of electrical machine in accordance with the present invention transverse its rotational axis;

FIG. 2 is an exploded view of the electrical machine of FIG. 1;

FIG. 3 is an isometric view of an alternative embodiment of electrical machine in accordance with the present invention, with some parts being shown in section and with some parts shown omitted; and

FIGS. 4A to 4E are schematic views showing various opposed profiled surfaces of the ends of the stator teeth and the permanent magnets of alternative embodiments of electrical machine in accordance with the present invention.

### DETAILED DESCRIPTION OF THE PREFERRED EMBODIMENTS

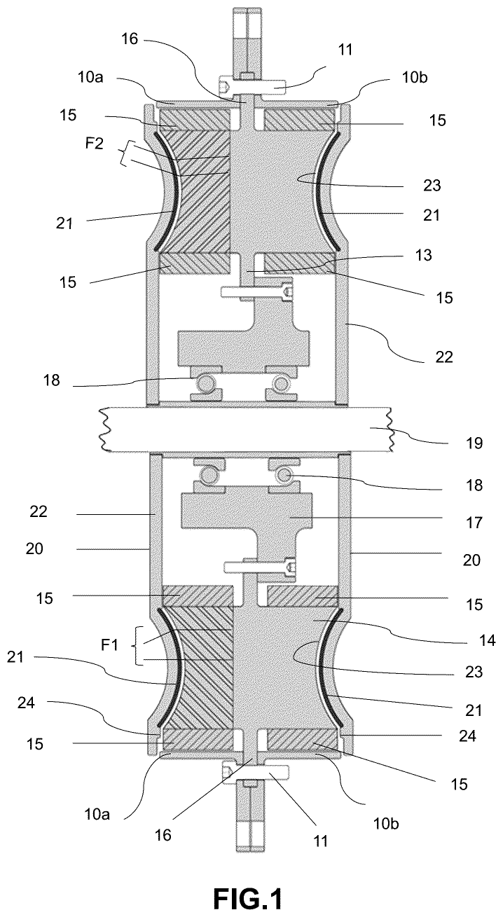

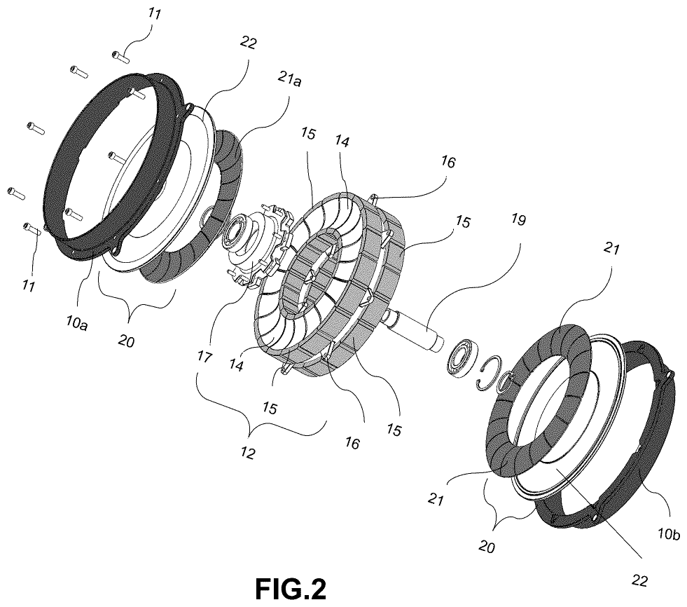

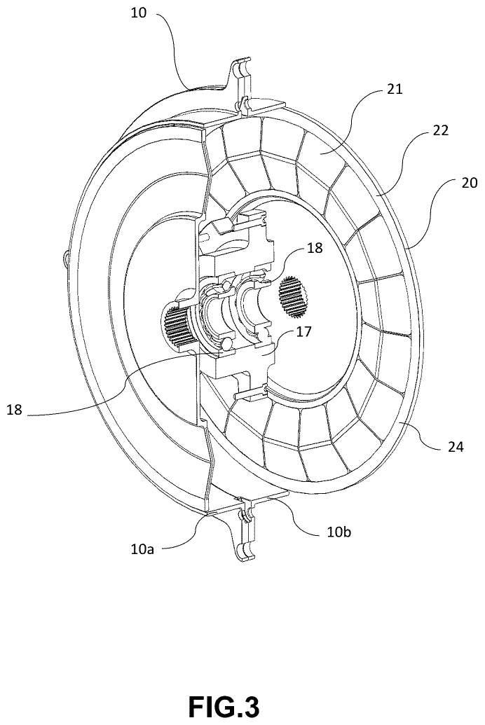

Referring to FIGS. 1 to 3 of the drawings, there is shown an electrical machine which may function as either a motor or a generator, or both (at different times). Although FIGS. 1 and 2 show a different embodiment of the electrical machine than that of FIG. 3, as will be explained hereinafter, the embodiments are practically identical in construction and reference to all drawings will aid the understanding of the invention.

The machine comprises a pair of flanged annular casings 10a, 10b which are clamped together by bolts 11 to form a tubular stator housing 10. A stator 12 is fixed inside housing 10 and comprises an annular outer former portion 13 of ferromagnetic material, the outer former 13 having a plurality of oppositely directed axially extending stator teeth 14 around which stator coils 15 are disposed of. The former portion 13 comprises radially extending tabs 16 which are clamped between the flanged annular casings 10a, 10b to hold the stator 12 in situ inside the housing 10.

In the embodiment of FIGS. 1 and 2, the axially outer end face of each stator tooth 14 is of a concave profile and has an outer portion which uniformly curves axially inwardly from its radially outer edge to its centre and an inner portion which uniformly curves axially inwardly from its radially inner edge to its centre. In the embodiment of FIG. 3, the axially outer end face of each stator tooth (not shown) is of a concave profile and has a flat outer portion which is angled axially inwardly from its radially outer edge to its centre and a flat inner portion which is angled axially inwardly from its radially inner edge to its centre, thereby forming a V-shaped profile.

The stator 12 further comprises an inner hub portion 17 mounted inside the former portion, the hub portion 17 having an axially-extending through aperture in which a pair of bearings 18 are disposed of. A rotary shaft 19 extends through the hub portion 17 and is supported by the bearings 18. The rotary shaft 19 has an axis of rotation which extends parallel to the axis of each stator coil 15.

The machine further comprises a pair of rotors 20 which are spaced apart from the stator 12 along the axis of the shaft 19 on respective opposite sides thereof. The rotors 20 each comprise a plurality of permanent magnets 21 arranged circumferentially around the edge of a ring-shaped back iron 22 which is then mounted on the rotor hub 22a. The radially outer edges of the permanent magnets 21 abut against a lip 24 in order to constrain the magnets against displacement during high-speed rotation. Further, a pair of bearings 18 is positioned to support shaft 19 while allowing the shaft 19 to rotate. The magnets 21 are arranged on the surface of the ring-shaped back iron 22 so that they face towards the profiled stator teeth 14, the magnets 21 having a convex profile which complements that of the stator teeth 14. The disc-shaped rotor hub 22a of the rotors 20 each have an axially extending aperture through which the shaft 19, the shaft 19 being fixed against rotation relative to the rotors 20 such that rotation of the rotors 20 causes rotation of the shaft 19 and vice-versa. The disc-shaped rotor hub 22a of the rotors 20 acts to close respective opposite ends of the tubular stator housing 10.

In use as a motor, a polyphase electrical current is applied to the stator coils 15 to generate a magnetic field which rotates about the rotary shaft 19, each coil 15 generating a respective magnetic field which extends parallel to the axis of the rotary shaft 19. The rotating magnetic field formed by the stator coils 15 interacts with the separate magnetic fields produced by the permanent magnets 21, thereby causing the rotors 20 to rotate.

An active air gap 23 between the opposed profiled surfaces of the ends of the stator teeth 14 and the permanent magnets 21 has a surface area which is substantially greater than that of conventional axial flux electrical machines. The profiled shape of the stator teeth 14 and the permanent magnets 21 allows the rotors 20 to rotate freely relative to the stator 12. As shown in FIG. 1, the lines of flux F1 extending in the air gap 23 may extend perpendicular to the respective points on the curved surfaces between which they extend depending on how the permanent magnets 21 have been magnetized. Alternatively, the lines of flux F2 extending in the air gap 23 may extend in a non-perpendicular direction depending on the position of the rotating magnetic field relative to the permanent magnets 21.

The arrangement of the opposed profiled surfaces of the ends of the stator teeth 14 and the permanent magnets 21 increases the active surface area which in turn increases the torque and the specific power density of the machine by at least 10% in the same given volume of the electric machine.

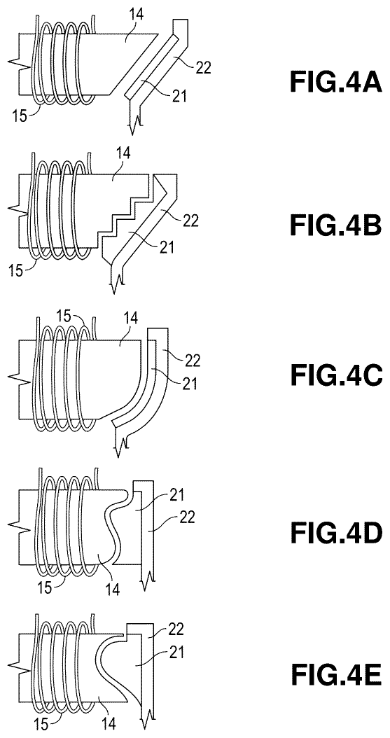

It will be appreciated that the opposed profiled surfaces of the ends of the stator teeth 14 and the permanent magnets 21 can have a variety of profiles other than the conventional planar profile that lies perpendicular to the rotational axis. Referring to FIGS. 4A to 4C of the drawings, examples of some envisaged profiles include a single angled profile (FIG. 4A), a stepped profile (FIG. 4B), a non-uniformly curved c-shaped profile (FIG. 4C), a wave-shaped profile having both convex and concave portions (FIG. 4D), a profile having both curved and flat portions (FIG. 4E) or any convex or concave profile that allows free rotation of the rotors 20. The ends of the stator teeth 14 have a complementary shape so that the air gap is minimized. Different profiles can be used in the same machine in order to reduce cogging torque and torque ripple of the electric machine.

Some of the profiled designs may yield more than 15% of the specific power density. The use of non-planar profiles does not increase the complexity of manufacturing. Referring to Table 1, we found experimentally that the curved profile of the embodiment of FIGS. 1 and 2 approximately exhibits a 10.2% increase in surface area compared with conventional planar profiles and is particularly advantageous. The V-shaped profile of the embodiment of FIG. 3 approximately exhibits a 3.7% increase in surface area compared with conventional planar profiles.

TABLE 1

| | Area | % Area | | Total Magnet Mass | |
|---|---|---|---|---|---|
| Magnet | (mm\hat{ }2) | Increase | Mass | g | % Mass increase |
| Flat | 3178 | 0.0% | 45.98 | 1655 | 0.0% |
| Curved | 3503 | 10.2% | 50.18 | 1806 | 9.1% |
| Angled | 3295 | 3.7% | 47.46 | 1709 | 3.2% |

Since the torque and power of a motor are exponentially proportional to the active surface area of the magnetic flux between the ends of the stator teeth 14 and the permanent magnets 21, the increases provided by the present invention substantially increase the power density compared with conventional axial flux machines.

An electrical machine in accordance with the present invention exhibits a substantially increased efficiency compared with a conventional axial flux machine of the same size and utilising the same materials. Although the invention has been described and illustrated with reference to specific embodiments thereof, it is not intended that the invention be limited to such illustrative embodiments. Those of skill in the art will recognise that many variations and modifications of such embodiments are possible without departing from the spirit of the invention. Accordingly, it is intended to be included within the invention all such variations and modifications as fall within the scope of the appended claims.

1. A permanent magnet electrical machine, the machine comprising:
a stator having:
a plurality of ferromagnetic stator teeth disposed circumferentially at intervals about a rotational axis of the machine; and
a plurality of stator coils having respective coil axes extending parallel to said rotational axis of the machine, each coil extending axially around a respective said stator tooth, and
a rotor having a plurality of permanent magnets disposed circumferentially around said rotor and mounted for rotation about said rotational axis of the machine, and wherein said rotor and stator are axially spaced apart along said rotational axis of the machine to define a gap therebetween in which magnet flux in the machine extends generally in an axial direction, wherein said stator teeth and said magnets comprise opposed faces on opposite sides of said air gap of a complementary profile having both a radially-facing and an axially-facing component of inclination relative to said rotational axis of the machine.

2. A permanent magnet electrical machine as claimed in claim 1, in which one of said opposed surfaces has a convex profile and the other has a concave profile.

3. A permanent magnet electrical machine as claimed in claim 1, in which each opposed surface has a portion of a convex profile and a portion of a concave profile.

4. A permanent magnet electrical machine as claimed in claim 1, in which each opposed surface has a flat portion which lies in a plane extending at an angle of between 5 and 85 degrees to the rotational axis.

5. A permanent magnet electrical machine as claimed in claim 4, in which each flat lies in a plane extending at an angle of between 40 and 50 degrees to the rotational axis.

6. A permanent magnet electrical machine as claimed in claim 1, in which each opposed surface has a V-shaped profile.

7. A permanent magnet electrical machine as claimed in claim 1, in which each opposed surface has a portion having a curved profile.

8. A permanent magnet electrical machine as claimed in claim 1, comprising a plurality of rotors and/or stators mounted axially of each other along said rotational axis of the machine.

9. A permanent magnet electrical machine as claimed in claim 1, in which the permanent magnets are disposed on a face of a body portion of the rotor.

10. A permanent magnet electrical machine as claimed in claim 1, in which the body portion of the rotor is formed of a ferromagnetic material.

11. A permanent magnet electrical machine as claimed in claim 1, in which the stator is mounted inside a tubular housing of the motor, the rotor forming an end wall of the housing.

12. A permanent magnet electrical machine as claimed in claim 1, in which the lines of flux extending in the air gap may extend perpendicular to the respective points on the curved surfaces between which they extend.

13. A permanent magnet electrical machine as claimed in claim 1, in which the lines of flux extending in the air gap may extend in a non-perpendicular direction.
